(19) United States
(12) Patent Application Publication
(10) Pub. No.: US 2025/0172919 A1
(43) Pub. Date: May 29, 2025

(54) Recipe Builder User Interface

(71) Applicant: SWIMC LLC, Cleveland, OH (US)

(72) Inventors: Phillip M. Abbott, Pell City, AL (US); Derek Binkley, Madison, WI (US); Anthony Kramer, Hayfield, MN (US); Grant Krieger, Orono, MN (US); Daniel C. Malyszko, Lakewood, CO (US); Mary McDermott, St. Paul, MN (US); Michael Willbanks, Shakopee, MN (US)

(21) Appl. No.: 18/523,483

(22) Filed: Nov. 29, 2023

(51) Int. Cl. G05B 19/05

(52) U.S. Cl. CPC G05B 19/05; G05B 2219/163

(57) ABSTRACT

Disclosed herein are improvements to a user interface for building recipes for batch processing. In one embodiment, when a user hovers over phase, the user interface provides a mechanism for the user to either add or edit a transition. If the user hovers over a transition, the user is provided with a mechanism for adding a step. In another embodiment, a user can add comments that are linked to a phase. The user can then either retrieve the comment for a phase, or a phase linked to a comment. In yet another embodiment, the user can add an automated deferment to another level.

### TECHNICAL FIELD

The present disclosure relates generally to user interfaces such as for example user interfaces for control and monitoring systems.

### BACKGROUND

Recipes are typically used for batch automation of manufactured products, such as chemicals, coatings, and many other manufactured products. Recipes can include equipment capabilities and performance, ingredients added to the batch at various points, transitions that occur to move between steps, and overall strategies of steps to process input to product in various process cells. Programming logic controller (PLC) based programming is often used to program a controller for a process. A recipe building application, or Recipe Builder, provides a graphical user interface (“GUI”) provides a mechanism for a user to graphically represent a process that can be employed to program the controller to perform the process.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, a user interface for a recipe building application. Upon detecting an input device such as a mouse or trackball hovering over a phase, the user interface presents an icon that when selected allows a user to add a transition. In other embodiments, the user interface provides an edit transition icon in response to detecting an input device hovering over a phase. In yet another embodiment, the user interface provides an icon that when selected enables a user to add a step when selected upon detecting the input device hovering over a transition. Other embodiments include methods and computer readable of mediums of instructions that when executed implement the user interfaces described herein.

In accordance with an example embodiment, there is disclosed herein a user interface for a recipe building application that is operable to allow a user to add a comment to a phase. When the user saves the comment, the comment is linked to the phase and an icon appears on the phase to indicates there is a comment linked to the phase and provides access to the comment.

In accordance with an example embodiment, there is disclosed herein a user interface for a recipe building application that includes a method for adding a deferment to a parameter. Upon receiving an input to defer a parameter, the user interface automatically presents visual representations of available levels. A level is selected and the user interface provides a prompt to confirm the selection. Upon confirmation, the parameter is deferred to the selected level and the user interface provides an indication that the parameter is deferred.

### BRIEF DESCRIPTION OF THE DRAWINGS

The accompanying drawings incorporated herein and forming a part of the specification illustrate the example embodiments.

FIG. 1 is a simplified block diagram of a system for providing a user interface upon which an example embodiment can be implemented.

FIG. 2 is a screen snapshot illustrating an example user interface for adding a transition or editing a step parameter to a recipe.

FIG. 3 is screen snapshot for illustrating an example user interface for adding a step to a recipe.

FIG. 4 is a screen snapshot for illustrating an example user interface for adding a comment to a recipe.

FIG. 5 is a screen snapshot for illustrating an example user interface for reviewing a comment for a recipe.

FIG. 6 is a screen snapshot for illustrating an example user interface for reviewing a plurality comments for a recipe.

FIG. 7 is a screen snapshot for illustrating an example user interface for adding a parameter to a recipe element.

FIG. 8 is a screen snapshot for illustrating an example user interface for confirming a deferment for an added element.

FIG. 9 is a screen snapshot for illustrating an example user interface for reviewing a deferred parameter for a recipe element.

FIG. 10 is a screen snapshot for illustrating an example user interface for reviewing parameters for a recipe element.

FIG. 11 is a screen snapshot for illustrating an example user interface for selecting a deferment for a recipe element.

FIG. 12 is a screen snapshot for illustrating an example user interface for confirming a selected deferment for a recipe element.

FIG. 13 is a block diagram illustrating a method for adding a transition or editing step parameters of a recipe.

FIG. 14 is a block diagram illustrating a method for adding a step to a recipe.

FIG. 15 is a block diagram illustrating a method for adding and reviewing comments for a recipe.

FIG. 16 is a block diagram illustrating a method for adding a deferment to a recipe element.

FIG. 17 is a block diagram of a computer system upon which an example embedment can be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed herein are improvements to a user interface for building recipes for batch processing. In one embodiment, when a user hovers over phase, the user interface provides a mechanism for the user to either add or edit a transition. If the user hovers over a transition, the user is provided with a mechanism for adding a step. In another embodiment, a user can add comments that are linked to a phase. The user can then either retrieve the comment for a phase, or a phase linked to a comment. In yet another embodiment, the user can add an automated deferment to another level.

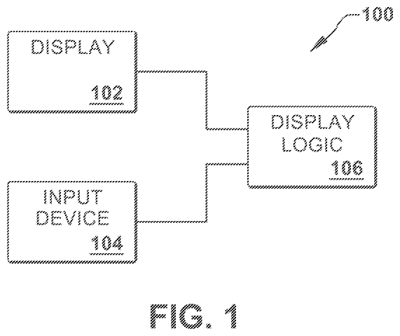

FIG. 1 is a simplified block diagram of a system 100 for implementing a user interface upon which an example embodiment can be implemented. The system 100 comprises a display 102, an input device 104, and display logic 106.

The display 102 can be any type of device that provide a visual representation of data. The visual representation of data can be graphical and/or textual. In an example embodiment, the display is operable to be divided into a plurality of panes. The panes can be employed to segregate different types of data, For example, recipe construction pane can be employed to output a graphical representation of a recipe. A parameters pan can be employed for displaying and/or editing associated with a step or phase. A navigation and settings bar employed to navigate the recipe and change the edit mode. A location pane can be employed for providing a graphical representation of where in a recipe editing is occurring. The display 102 can be a liquid crystal display (LCD), Light Emitting Diode Display (LED) or any other suitable type of device for providing graphical and/or textual output.

The input device 104 can be any type of device that receive inputs from a user. The input device 104 can comprise an input device such as a mouse, trackball, or any other suitable type of cursor control and/or a textual input device such as a keyboard. In an example embodiment, the input device 104 comprise a touch screen.

The display logic 106 is coupled with the display 102 and input device 104 and comprises logic for performing the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by one or more processors. The display logic 106 can provide data to a controller (not shown) or other logic associated with a recipe building application based on inputs received from input device 104 and can output data provided by the recipe building application on display 102. In an example embodiment, the display logic 106 is implemented by a one or more processors that are executing a recipe builder application.

The display logic 106 is operable to cause data, or visual representations of data to be output on the display 102. The display logic 106 is further operable to receive inputs from the input device 104. The display logic 106 also facilitates communication between the display 102 and input device 104. For example, the display logic 106 can cause an indication to appear on the display 102 that indicates where on the display 102 editing is occurring. For example, the display logic can cause a cursor to appear on the screen to allow a user to navigate and select a symbol and/or an area to enter textual data.

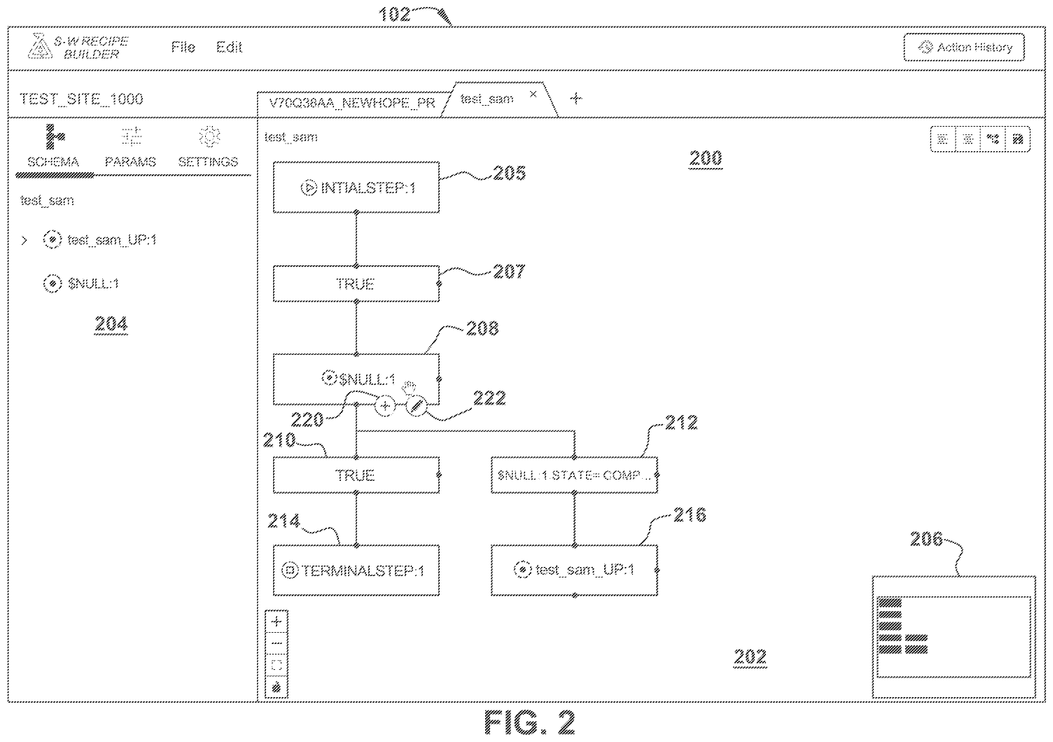

FIG. 2 is a screen snapshot 200 illustrating an example user interface for adding or editing a transition to a recipe. The screen snapshot 200 is output on display 102 and comprises a recipe construction pane 202, a vertical navigation and settings bar 204, and a location pane 206. The recipe construction pane 202 provides a graphical representation of phases 205, 208, 214, 216 and transitions 207, 210, 212 of a recipe. As those skilled in the art can readily appreciate, the number and arrangement of steps and transitions illustrated in FIG. 2 were selected merely for ease of illustration. In the illustrated example, the vertical navigation and settings bar 204 illustrates what part of the recipe (step 208) is being edited. The location pane 206 provides a visual indication of the part of the recipe that is being displayed in the recipe construction pane 202.

In an example embodiment, the display logic is operable to cause a visual representation of a phase 208 of a procedure to be output on the display 102. The display logic 106 is operable to receive data from the input device 104 indicating that the input device is hovering (e.g., a pointing device remaining over an area bounded by the phase for more than a predefined time period such as, for example, one-half or one second) over the phase 208. The display logic 106 is operable to cause a visual representation of an add transition icon 220 to appear on the display 102. In the illustrated example a plus sign “+” is displayed in a circular area but as those skilled in the art can readily appreciate any suitable icon can be employed. In a particular embodiment, the add transition icon 220 at least partially overlap the selected phase icon 208. Upon selecting of the icon 220 by the input device 104, the display logic 106 is operable to present a visual representative of a new transition to appear on display 102 and accept data representative of a new transition via input 104.

In an example embodiment, the display logic is operable to cause a visual representation of a phase 208 of a procedure to be output on the display 102. The display logic 106 is operable to receive data from the input device 104 indicating that the input device is hovering over the phase 208. The display logic 106 is operable to cause a visual representation of an edit step parameter icon 222 to appear on the display 102. In the illustrated example a pencil is displayed in a circular area but as those skilled in the art can readily appreciate any suitable icon can be employed. In a particular embodiment, the edit step parameter icon 222 at least partially overlap the selected phase icon 208. Upon selecting of the icon 222 by the input device 104, the display logic 106 is operable to present one or more step parameter on display 102 for editing and allow editing of the one or more step parameters via input device 104.

In an example embodiment, the display logic is operable to cause a visual representation of a phase 208 of a procedure to be output on the display 102. The display logic 106 is operable to receive data from the input device 104 indicating that the input device is hovering over the phase 208. The display logic 106 is operable to cause a visual representation of an add transition 220 icon and an edit step parameter 222 to appear on the display 102. In a particular embodiment, the add transition icon 220 and the edit step parameter icon 222 at least partially overlap the selected phase icon 208. The user can select via the input device 104 either the add transition icon 220 or the edit step parameter icon 222 to edit a step parameter. Selecting the add transition icon 220 by the input device 104 will cause the display logic 106 to present a new transition on display 102 and accept data for the new transaction via input device 104. Selecting the edit step parameters icon 222 will cause the display logic 106 to present one or more step parameters for editing and accept edits via input device 104.

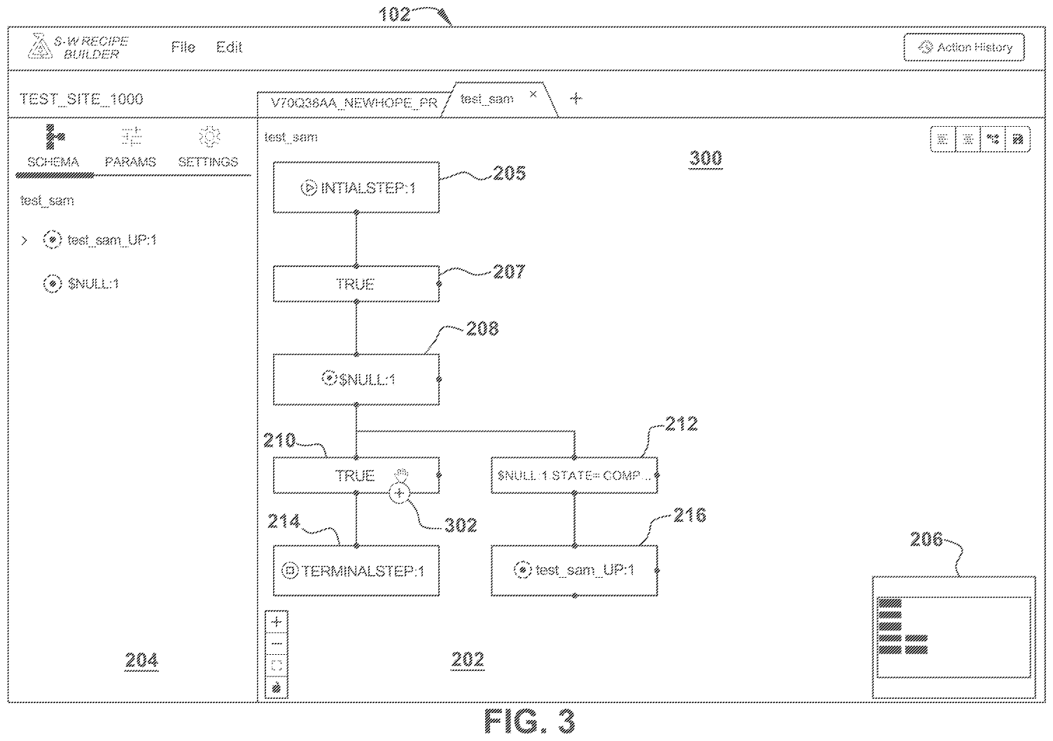

FIG. 3 is screen snapshot 300 illustrating an example user interface for adding a step to a recipe. The screen snapshot 300 is output on display 102 and comprises a recipe construction pane 202, a vertical navigation and settings bar 204, and a location pane 206. The recipe construction pane 202 provides a graphical representation of phases 205, 208, 214, 216 and transitions 207, 210, 212 of a recipe. As those skilled in the art can readily appreciate, the number and arrangement of steps and transitions illustrated in FIG. 3 were selected merely for ease of illustration.

In an example embodiment, the display logic is operable to cause a visual representation of a transition 210 of a procedure to be output on the display 102. The display logic 106 is operable to receive data from the input device 104 indicating that the input device is hovering over the transition 210. The display logic 106 is operable to cause a visual representation of an add step icon 302 to appear on the display 102. In the illustrated example a plus “+” sign is displayed in a circular area, but as those skilled in the art can readily appreciate any suitable icon can be employed. In a particular embodiment, the add step icon 302 at least partially overlap the selected phase icon 208. Upon selecting of the icon 220 by the input device 104, the display logic 106 is operable to present a visual representative of a new step to appear on display 102 and accept data representative of a new step via input 104.

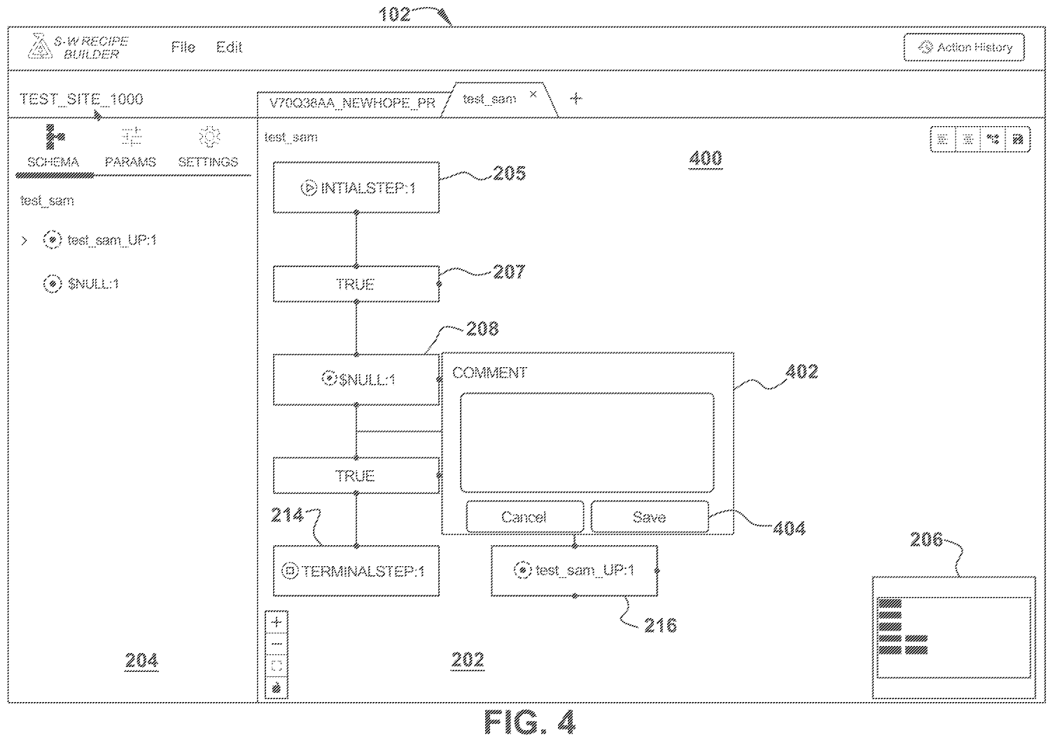

FIG. 4 is a screen snapshot 400 for illustrating an example user interface for adding a comment to a recipe. The screen snapshot 400 is output on display 102 and comprises a recipe construction pane 202, a vertical navigation and settings bar 204, and a location pane 206. The recipe construction pane 202 provides a graphical representation of phases 205, 208, 214, 216 and transitions 207, 210, of a recipe. As those skilled in the art can readily appreciate, the number and arrangement of steps and transitions illustrated in FIG. 4 were selected merely for ease of illustration.

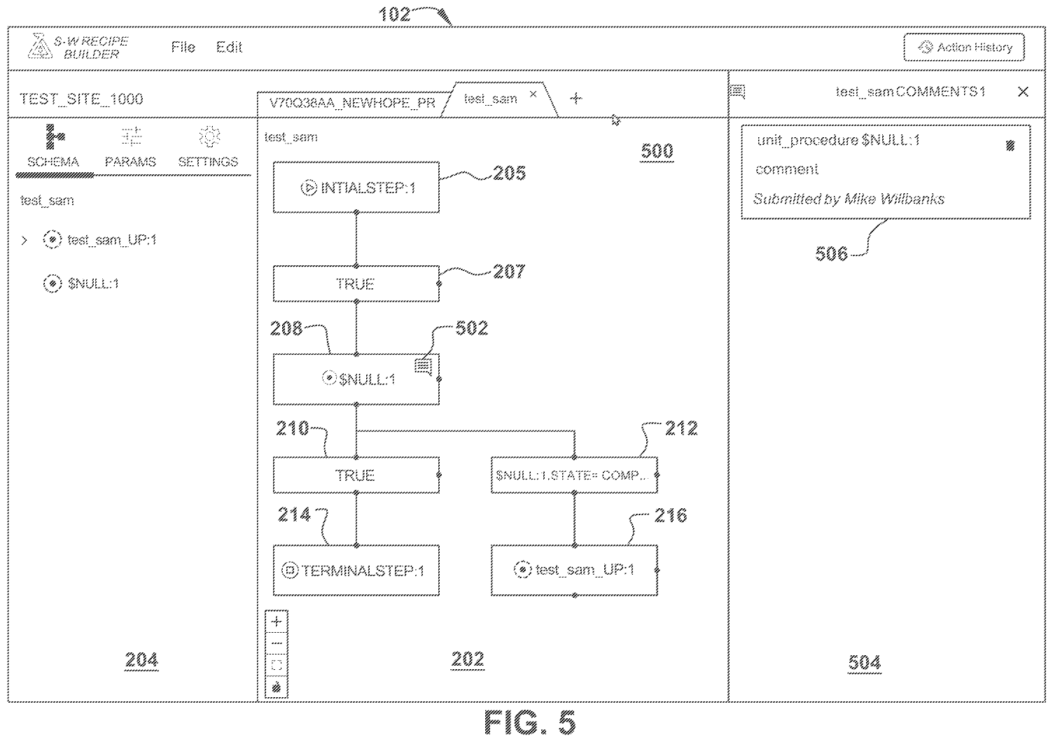

In an example embodiment, the display logic 106 is operable to receive a predefined input from the input device requesting to add a comment to the phase. For example, if the input device 104 is a pointing device such as a mouse, a user can select the phase to add a comment to (phase 208 in the illustrated example) by performing a predefined action, such as for example a right click of a mouse. The display logic is operable to cause a comment box 402 to be displayed on the display 102 and obtain a comment to be added into the comment box 402 via the input device 404. After the comments has been entered, the user selects the Save button 404 to save the comment, and the comment is stored with a link to a phase and a visual representation of a comment icon 502 appears on the phase 208 as illustrated in FIG. 5.

FIG. 5 is a screen snapshot 500 for illustrating an example user interface for reviewing a comment for a recipe. The display logic 106 receiving data from the input (pointing) device 104 indicating that the visual representation of the comment icon 502 for the phase 208 has been selected. The display logic 106 causes a the comment linked to the phase 208 to be displayed in a comment pane 504, and the procedure to be displayed in a recipe construction pane responsive to receiving data from the input (pointing) device 104 indicating the visual representation of the comment icon 502 for the phase 208 has been selected

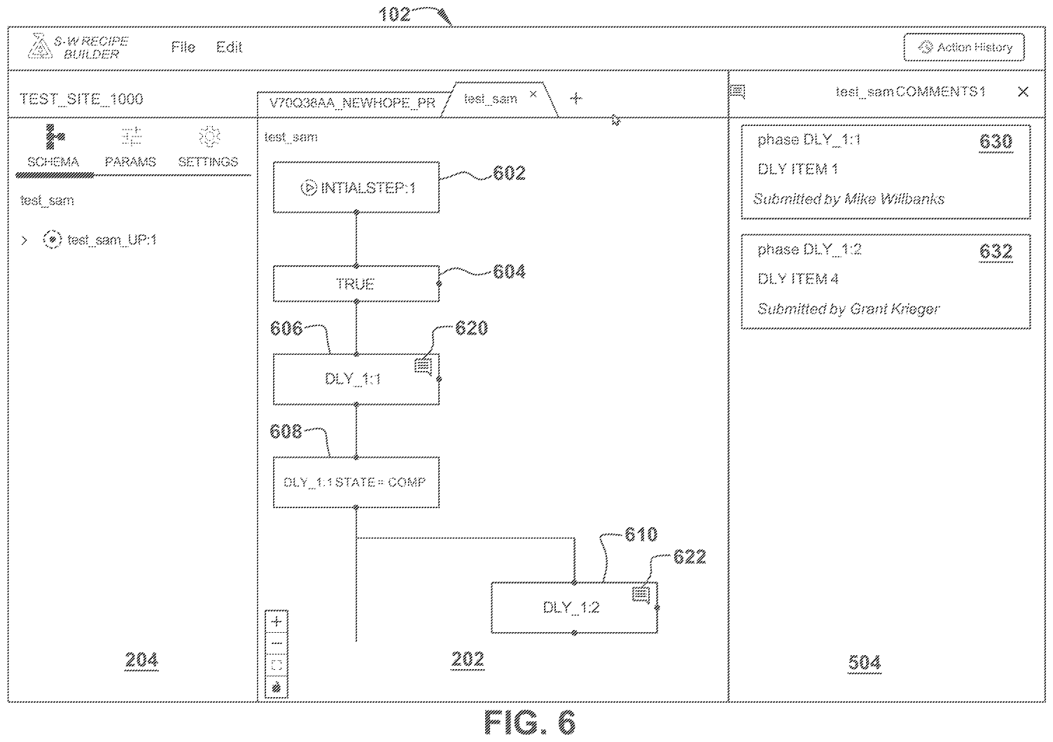

FIG. 6 is a screen snapshot 600 for illustrating an example user interface for reviewing a plurality comments 630, 632 for a recipe. In the illustrated example, the screen snapshot comprises a recipe construction pane 202 and a comments pane 504. The construction recipe pane 202 displays at least a portion of a recipe, which in the illustrated example comprises visual representations of phases 602, 606, 610 and transitions 604, 608. The visual representation of phase 606 comprises a comment icon 620 and the visual representation of comments 610 comprises a comment icon 622. In this example, comment 630 is linked to phase 606 and comment 632 is linked to phase 622.

In an example embodiment, the display logic receiving data from the input (pointing) device 104 indicating the visual representation of the comment icon 620 for the phase 606 has been selected. The display logic 106 is responsive to the input to cause a plurality of comments 630, 632 to be displayed in a comment pane 504 that includes the comment 630 linked to the phase 620.

In an example embodiment, the display logic 106 is operable to receive data from the input (pointing) device 104 indicating a comment was selected from the plurality of comments 630, 632. The display logic 106 is operable to display the phase (e.g., phase 622) that is linked to the selected comment (e.g., 632) in the recipe construction window 202.

As those skilled in the art can readily appreciate, because the comment is linked to the phase, if the phase is moved, the comment will remain associated with the phase. This prevents losing track of the comment.

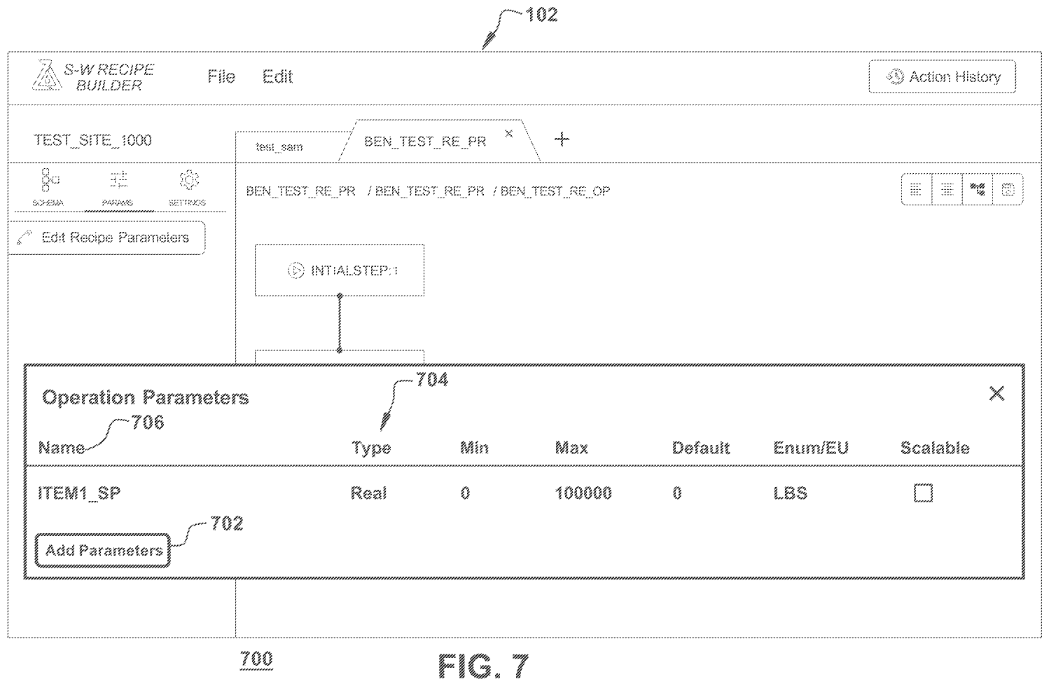

FIG. 7 is a screen snapshot 700 for illustrating an example user interface for adding a parameter to a recipe element. In the illustrated example, an operation parameter has a name 706 and a type 704. A button 702 is provided for a user to add a parameter.

In an example embodiment, upon selecting button 702 by the input device (e.g., a pointing device such as a mouse) 104, the display logic 106 provides a prompt on the display 102 for entering information associated with the parameter being added. The user will be prompted to input, inter alia, a name for the parameter, a type for the parameter, and an origin of the parameter.

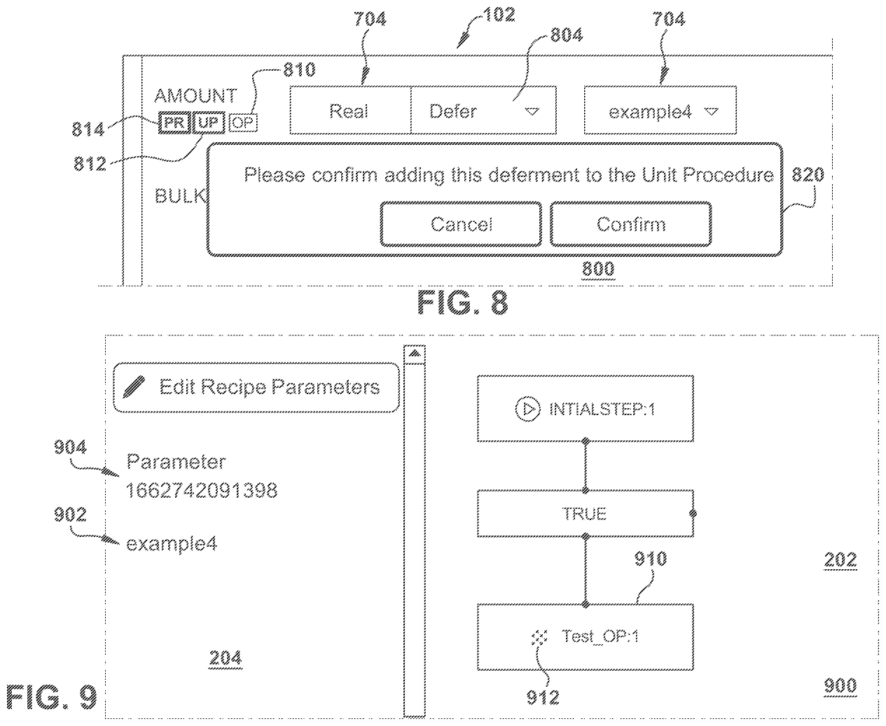

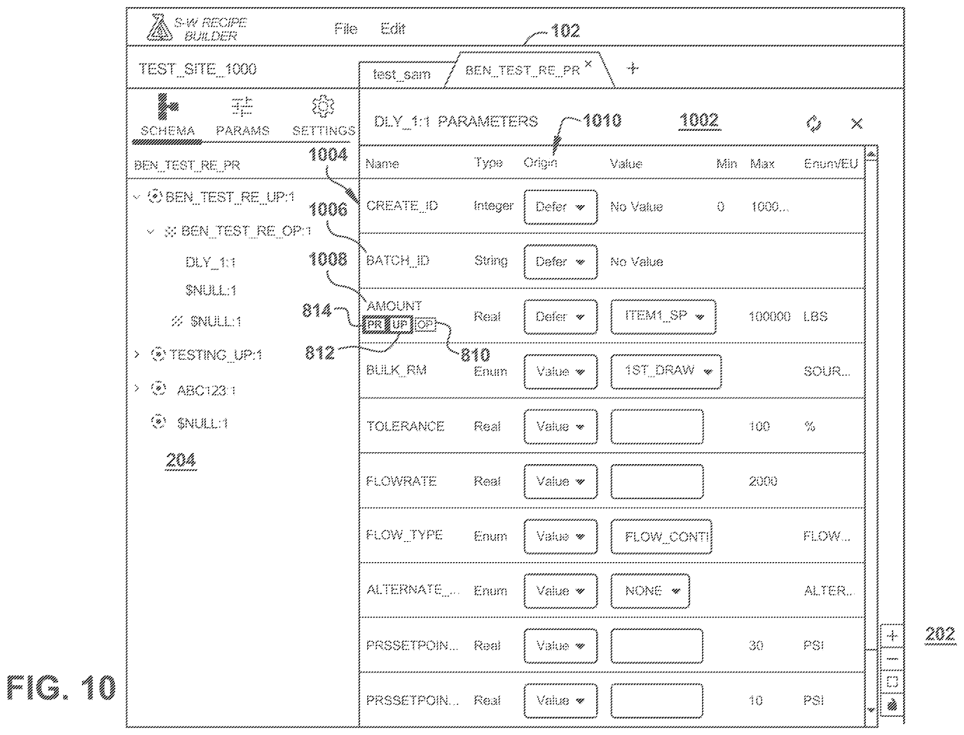

FIG. 8 is a screen snapshot 800 for illustrating an example user interface for confirming a deferment for an added element. In the illustrated example, the parameter name 706 is “Example 4,” the type 704 is Real, and the origin 804 is defer. In an example embodiment, when defer is the type of origin, the display logic 106 automatically determines available upper levels having matching name with the same type. An example of this will be further illustrated in FIG. 10 described herein infra. In FIG. 8, the visual representations of the levels displayed are Operational (“OP”) 810, Unit Procedure (“UP”) 812, and Procedure (“PR”) 814. In an example embodiment, since the parameter being added is at the operational level, the OP 810, the visual representation for OP 810 is faded, however, those skilled in the art can readily appreciate that any suitable scheme, such as different colors, can be employed to distinguish the current level from upper levels.

Upon selecting an upper level for deferment via the input device 104, the display logic causes a confirmation box 820 to be output on the display 102. In the illustrated example, the user is asked to confirm deferment to the Unit Procedure level.

FIG. 9 is a screen snapshot 900 for illustrating an example user interface for reviewing a deferment for a recipe element. With continued reference to the example in FIG. 8, in the navigation bar 204, the deferment of Example 4 is illustrated as deferring from the parameter indicated by 904. In the customer recipe screen 202, a visual representation (deferment icon) 912 is associated with recipe element 910 (an operation). However, those skilled in the art can readily appreciate, recipe element 910 can be from any level below procedure, i.e., Unit Procedure, Operation, or Phase.

FIG. 10 is a screen snapshot 1000 for illustrating an example user interface for reviewing parameters for a recipe element. In this example, a parameter pane 1002 for displaying the properties of the parameters is disposed between recipe construction pane 202 and the vertical navigation bar 204. The user can employ input device 104 to edit a parameter, such as select the origin column 1010 for a parameter to change the origin for the parameter.

In an example embodiment, the display logic 106 is operable to receive a predefined defer input for a selected parameter for the recipe element from the input device 104. For example, the user can select an origin for a parameter and is presented with a drop down menu on display 102 and can employ the input device 104 to change the origin from value to defer or vice versa.

In the illustrated example, the parameters named Create_ID 1004, Batch_ID 1006, and Amount 1010 are deferred. In an example embodiment, the display logic 106 is operable to automatically display a visual representation of available levels that have a matching data type for the selected parameter. In the illustrated example, the display logic 106 automatically determines what levels are available for deferment. For this example, Create_ID 1004 and Batch_ID 1006 do not have a matching upper level value thus there are no deferment icons displayed and the value is listed as ‘No Value.’ However, the Amount 1008 parameter does, and therefore, the visual representations for OP 810 (which is the current level and is faded in this example), UP 812, and PR 814 are displayed, and the value lists the current deferment “ITEM1_SP.”

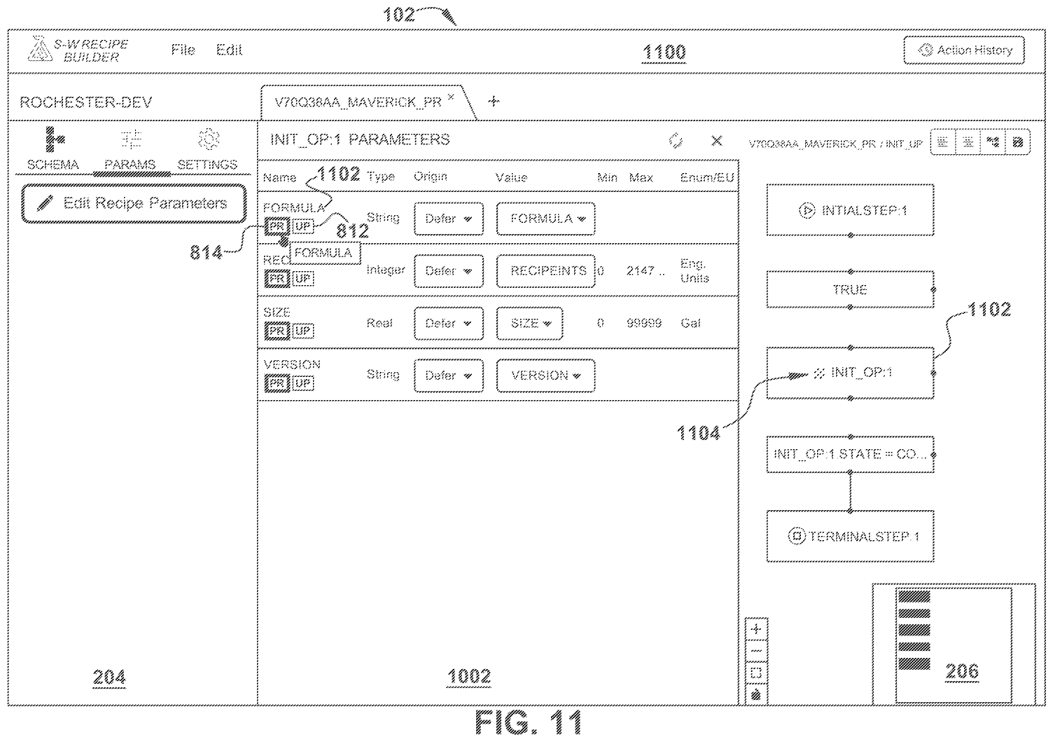

FIG. 11 is a screen snapshot 1100 for illustrating an example user interface for selecting a deferment for a recipe element. In this example, a deferment for the parameter Formula 1101 for the operation INT_OP:1 1102 is being deferred. Visual representations for OP (faded because this is the current level and un [selectable), UP 812, and PR 814. The user selects with the input device 104 the visual representation of the desired level. In the construction recipe panel 202, a visual representation of the recipe element 1102 is displayed with a visual representation (e.g., icon) indicating that the recipe element 1102 is deferred.

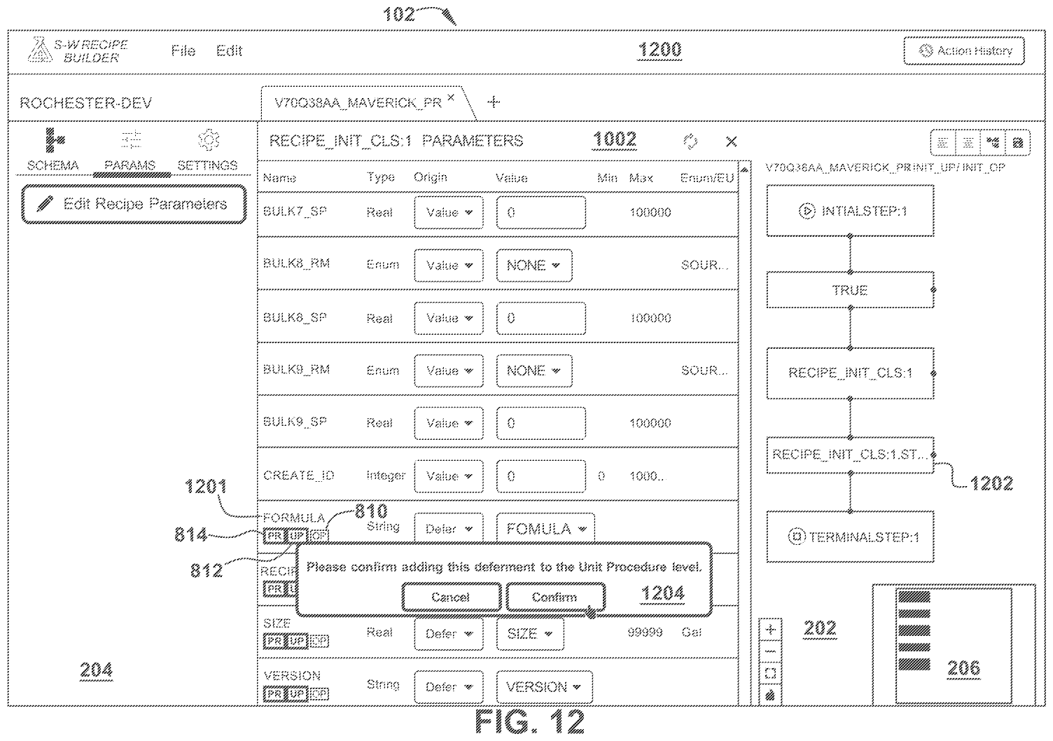

FIG. 12 is a screen snapshot 1200 for illustrating an example user interface for confirming a selected deferment for a recipe element. In the illustrated example, the UP 814 icon has been selected for the recipe element Formula 1201 for the Operation Recipe_Init_CS:1 1202. A visual representation of Operation Recipe_Init_CS:1 1202 is displayed in the recipe construction pane 1202.

The display logic 106 is operable to receiving a level selection input for the selected parameter (UP 812 in this example) to cause a confirmation prompt 1204 to appear on the display 102. The display logic 106 is operable to receive an input from the input device 104 via confirmation prompt confirming a deferment for the selected parameter to cause the parameter to defer to a level corresponding to the level selection input (UP in this example). Upon confirmation of the deferment, the display logic 106 is operable to cause the parameter to be deferred to a level that corresponds to the level selection input and display a visual representation (see e.g., 1104 in FIG. 11) of the deferment.

In view of the foregoing structural and functional features described above, a methodologies 1300, in accordance with an example embodiment will be better appreciated with reference to FIG. While, for purposes of simplicity of explanation, the methodology of FIG. is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment. The methodology described herein is suitably adapted to be implemented in logic, such as hardware, software stored on a computer readable medium when executed by a processor, or a combination thereof.

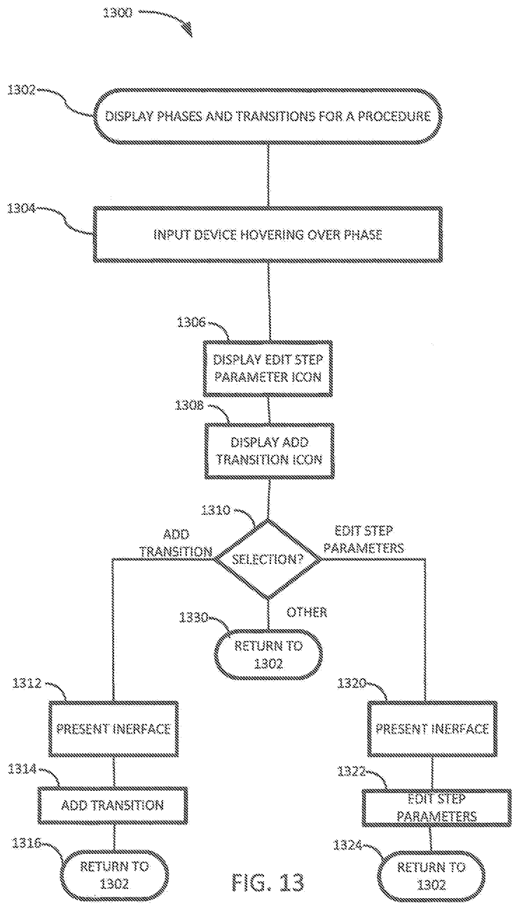

FIG. 13 is a block diagram illustrating a method 1300 for adding a transition or editing step parameters of a recipe. In an example embodiment, the method 1300 is implemented on the system 100 described in FIG. 1.

At 1302, phases and transitions of at least a portion of a recipe is displayed. In an example embodiment, the phases and transitions are displayed on display 106 in the recipe construction pane 202 (FIG. 2). Any physically realizable number and arrangement of phases and transitions can be displayed.

At 1304, an input device (e.g., input device 104 in FIG. 1) is detected hovering over a phase (e.g., an input device such as a pointing device, for example a mouse, is detected to have remained within the area bounded by the phase for a predefined time period, such as one-half or one second, or any desired time limit). In an example embodiment, the predefined time period for determining that an input device is hovering over a phase is configurable.

At 1306, in response to detecting the input device hovering over the phase, an edit step parameter icon is displayed (e.g., on display 102 in FIG. 1). The edit step parameter icon can be any desired icon. In the example illustrated in FIG. 2, the edit step icon comprises a pencil bounded within a circle that partially overlaps the phase where the input device was detected hovering over.

At 1308, in response to detecting the input device hovering over the phase, an add transition icon is displayed (e.g., on display 102 in FIG. 1). The edit add transition icon can be any desired icon. In the example illustrated in FIG. 2, the add transition icon 220 comprises a plus “+” sign bounded within a circle that partially overlaps the phase where the input device was detected hovering over.

At 1310, the method 1300 waits until a selection of either the Add Transition Icon, Edit Step parameters Icon is selected, or another action is taken. For example, the Add Transition icon can be selected by a pointing device, such as by right clicking a mouse, although other predefined actions can be taken if desired. Similarly, the Edit Step Parameters icon can be selected by a pointing device, such as by right clicking a mouse, although other predefined actions can be taken if desired.

If, at 1310, the add transition icon was selected (ADD TRANSITION), at 1312, an interface is presented to the user for the transition. The user is prompted for the transition parameters (e.g., temperature at or above one-hundred degrees Celsius, or solution is fifty percent X). In an example embodiment, the interface presented to the user depends on the parameters (e.g., type) of the selected phase (e.g., heat, mix, etc.).

At 1314, the transition is added. In an example embodiment, the transition is added to the phase that the input device was detected hovering over; however, in at least one other embodiment, the user can drag the transition to another desired phase. After the transition has been added, add transition and edit step parameters icons are no longer displayed and the method returns to 1302 and displays phases and transitions for a recipe and at 1304 waits for an input device to hover over a phase.

If, at 1320, the edit step parameters icon was selected (EDIT STEP PARAMETERS), at 1320, an interface is presented to the user for the edit the step parameters of the selected phase. In an example embodiment, the interface presented to the user depends on the parameters (e.g., type) of the selected phase (e.g., heat, mix, etc.).

At 1322, the step parameters are edited. After the step parameters have been edited, add transition and edit step parameters icons are no longer displayed and the method returns to 1302 and displays phases and transitions for a recipe and at 1304 waits for an input device to hover over a phase.

If, at 1310 some other action was detected (OTHER), the icons are removed from the display and processing returns to 1302 as indicated by 1330. For example, if the user selects or adds another phase or transition. Alternatively, if the user does not select either icon within a predefined time period, after the expiration of the predefined time periods the add transition and edit step parameters icons are no longer displayed and processing returns to 1302.

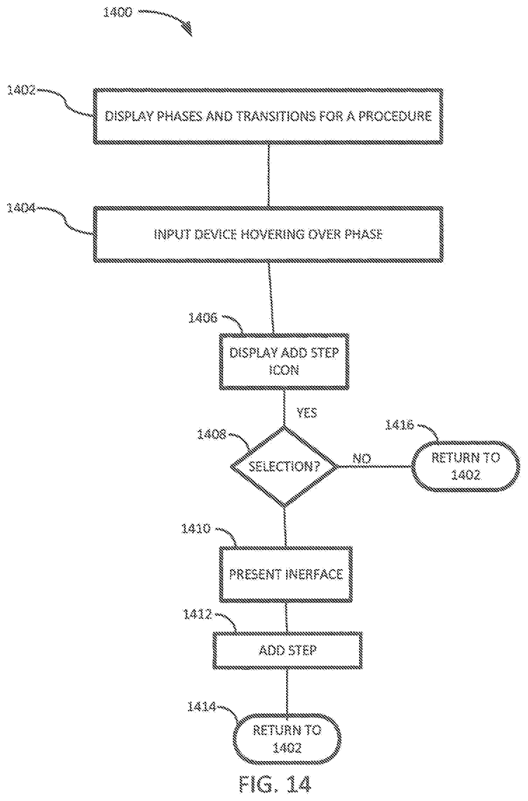

FIG. 14 is a block diagram illustrating a method 1400 for adding a step to a recipe. In an example embodiment, the method 1400 is implemented on the system 100 described in FIG. 1.

At 1402, phases and transitions of at least a portion of a recipe is displayed. In an example embodiment, the phases and transitions are displayed on display 106 in the recipe construction pane 202 (FIG. 3). Any physically realizable number and arrangement of phases and transitions can be displayed.

At 1404, an input device (e.g., input device 104 in FIG. 1) is detected hovering over a step (e.g., an input device such as a pointing device, for example a mouse, is detected to have remained within the area bounded by the step for a predefined time period, such as one-half or one second, or any desired time limit). In an example embodiment, the predefined time period for determining that an input device is hovering over a phase is configurable.

At 1406, in response to detecting the input device hovering over the transition, an add step icon is displayed (e.g., on display 102 in FIG. 1). The edit add step icon can be any desired icon. In the example illustrated in FIG. 3, the add step icon 302 comprises a plus “+” sign bounded within a circle that partially overlaps the transition where the input device was detected hovering over.

At 1408, the method 1400 waits until either the Add Step Icon is selected, or another action is taken. For example, the Add Step icon can be selected by a pointing device, such as by right clicking a mouse, although other predefined actions can be taken if desired.

If, at 1410, the add step icon was selected (YES), at 1412, an interface is presented to the user for the step. In an example embodiment, the interface presented to the user depends on the parameters (e.g., type) of the selected transition.

At 1412, the step is added. In an example embodiment, the step is added to the transition that the input device was detected hovering over; however, in at least one other embodiment, the user can drag the step to another desired transition. After the step has been added, add step and edit step parameters icons are no longer displayed and the method returns to 1402 and displays phases and steps for at least a portion of a recipe and at 1404 waits for an input device to hover over a phase.

If, at 1410 some other action was detected (NO), the icon is removed from the display and processing returns to 1402 as indicated by 1416. For example, if the user selects or adds another phase or step. Alternatively, if the user does not select the icon within a predefined time period, after the expiration of the predefined time periods the add step icon is no longer displayed and processing returns to 1402.

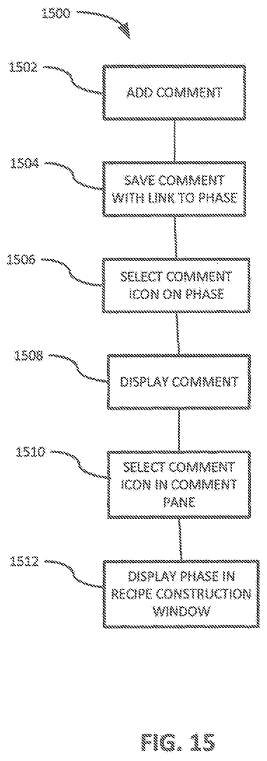

FIG. 15 is a block diagram illustrating a method 1500 for adding and reviewing comments for a recipe. In an example embodiment, the method 1500 is implemented on the system 100 described in FIG. 1.

At 1502, predefined input is received for adding a comment to a phase. In an example embodiment, the predefined input is a right mouse click although in other embodiments any suitable type of input can be employed. The user is then presented with a prompt for adding the comment and the user inputs the comment.

At 1504, the comment is saved. In addition to saving the comment, a link to the phase is created. Thus, if the phase is moved, the comment remains with the phase, preventing the comment from becoming lost. In addition, a visual representation of a comment icon is displayed on the phase where the comment was initiated.

At 1506, after the comment has been, the comment is selected. For example, appointing device, such as a mouse, can select the comment icon displayed on the phase.

At 1508, in response to the comment icon being selected at 1506, the comment linked to the phase where the comment icon was selected is displayed. In an example embodiment, the comment is displayed in a comment pane.

Alternatively, In an example embodiment, the user can select the comment and be presented with the phase that is linked with the comment. At 1510, the user employs a pointing device to select a comment in a comment pane.

At 1512, in response to the user selecting a comment at 1510, the phase linked to the comment is displayed in a recipe construction window. In particular embodiments that employ a location pane, the location within the recipe is also updated.

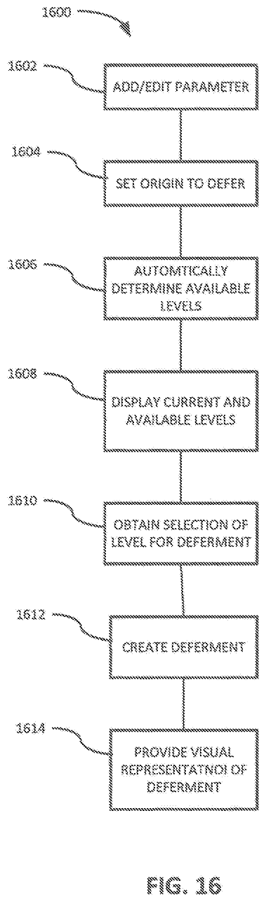

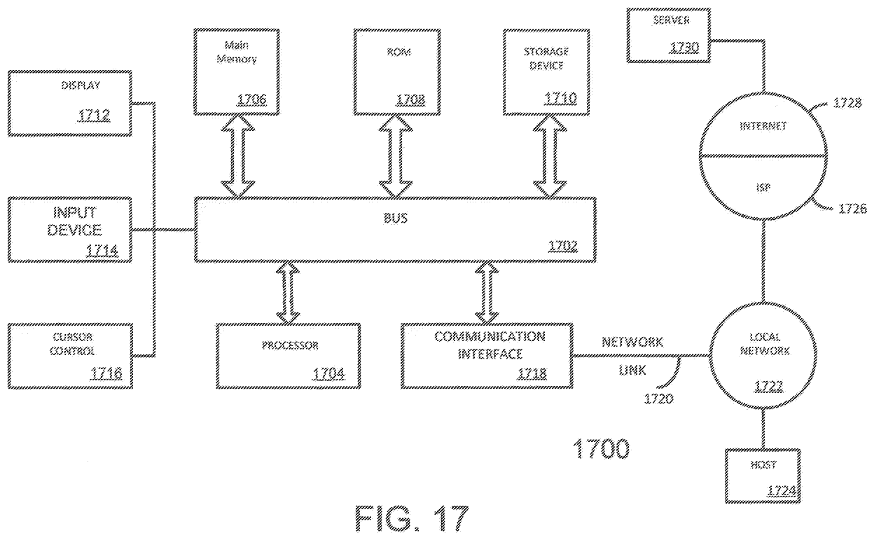

FIG. 16 is a block diagram illustrating a method 1500 for adding a deferment to a recipe element. The method 1500 can be implemented by display logic 106 which receives inputs via input device 104 and provides outputs (or visual representations of data) on display 102. Recipe elements are displayed in the recipe construction pane and parameters are displayed in a parameter pane.

At 1602, an input is received to add or edit a parameter for a recipe element. For a new parameter, an add parameter button is selected. For existing parameters, the parameter can be edited in the parameters pane. In an example embodiment, selecting Edit Parameters in the vertical navigation bar opens the parameter pane.

At 1604, a predefined defer input is received for the parameter being added or edited. In an example embodiment, the predefined input is selecting ‘Defer’ as the Origin of the parameter.

At 1606, the available levels are automatically determined. The available levels are upper levels that have matching types for the parameter. For example, for the operational level, the Unit Procedure, and Procedure levels are available.

At 1608, a visual representation of available levels that have a matching data type for the selected parameter are automatically display. In an example embodiment, the current level is displayed differently than the available levels (e.g., faded, different color, etc.). In an example embodiment, the levels are displayed so that they are associated with the name of the parameter being deferred.

At 1610, the level for deferment is obtained. In an example embodiment, the user employs a pointing device such as a mouse to select the level from the levels that are displayed on the screen. In an example embodiment, a confirmation prompt is presented to the user to confirm the selection.

At 1612, the deferment is created in response to obtaining the deferment in 1610. The deferment is to the selected level. At this point, the value of the parameter is deferred to the value of the selected level.

At 1614, a visual representation of the deferment is provided on the user interface. In an example embodiment, the deferment is displayed adjacent to the parameter name in the parameter pane. In another embodiment, an icon is displayed on the visual representation of the recipe element in the recipe construction pane. In yet another embodiment, a visual representation of the deferment is displayed in the vertical navigation bar.

FIG. 17 is a block diagram that illustrates a computer system 1700 upon which an example embodiment may be implemented. Computer system 1700 is suitable for implementing the system 100 in FIG. 1 and can implement the functionality described herein for FIGS. 2-12 and/or implement the methods 1300 (FIG. 13), 1400 (FIG. 14), 1500 (FIG. 15), 1600 (FIG. 16) described herein. The processor 1704 is suitable for implementing the functionality of display logic 106 described herein.

Computer system 1700 includes a bus 1702 or other communication mechanism for communicating information and a processor 1704 coupled with bus 1702 for processing information. Computer system 1700 also includes a main memory 1706, such as random access memory (RAM) or other dynamic storage device coupled to bus 1702 for storing information and instructions to be executed by processor 1704. Main memory 1706 also may be used for storing a temporary variable or other intermediate information during execution of instructions to be executed by processor 1704. Computer system 1700 further includes a read only memory (ROM) 1708 or other static storage device coupled to bus 1702 for storing static information and instructions for processor 1704. A storage device 1710, such as a magnetic disk or optical disk, is provided and coupled to bus 1702 for storing information and instructions.

Computer system 1700 may be coupled via bus 1702 to a display 1712 such as a cathode ray tube (CRT) or liquid crystal display (LCD), for displaying information to a computer user. An input device 1714, such as a keyboard including alphanumeric and other keys is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This input device typically has two degrees of freedom in two axes, a first axis (e.g. x) and a second axis (e.g. y) that allows the device to specify positions in a plane. In an example embodiment, the input device 1714 is a touch screen.

An aspect of an example embodiment is related to the use of computer system 1700 for a user interface for a recipe builder. According to one embodiment, a user interface for a recipe builder is provided by computer system 1700 in response to processor 1704 executing one or more sequences of one or more instructions contained in main memory 1706. Such instructions may be read into main memory 1706 from another computer-readable medium, such as storage device 1710. Execution of the sequence of instructions contained in main memory 1706 causes processor 1704 to perform the process steps described herein. One or more processors in a multi-processing arrangement may also be employed to execute the sequences of instructions contained in main memory 1706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media. Non-volatile media include for example optical or magnetic disks, such as storage device 710. Common forms of computer-readable media include for example RAM, PROM, EPROM, FLASHPROM, CD, DVD, SSD or any other memory chip or cartridge, or other medium from which a computer can read.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic, or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communications through the worldwide packet data communication network, now commonly referred to as the “Internet” 1728. Local networks 1722 and Internet 1728 both use electrical, electromagnetic, or optical signals that carry the digital data to and from computer system 1700, are exemplary forms of carrier waves transporting the information.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
a display;
an input device, the input device comprises a pointing device;
display logic coupled with the display and the input device;
the display logic is operable to cause a visual representation of a phase of a procedure to be output on the display;
the display logic is operable to receive data from the input device;
the display logic is operable to determine from data received from the input device that the input device is hovering over the phase;
the display logic is operable to cause a visual representation of an add transition icon to appear on the display; and
the display logic is operable to accept data representative of a new transition responsive to receiving data from the input device indicating selection of the add transition icon by the input device.

2. The apparatus set forth in claim 1, further comprising:
the display logic is operable to determining the input device is hovering over the phase to cause a visual representation of an edit step parameters icon to appear on the display;
the display logic is operable to allow a step parameter associated with the phase to be edited responsive to receiving data from the input device indicating selection of the edit step parameters icon by the input device.

3. The apparatus set forth in claim 2, further comprising:
the display logic is operable to determine from data received from the input device that the input device is hovering over a transition;
the display logic is operable to cause a visual representation of an add step icon to appear on the display; and
the display logic is operable to accept data representative of a new step responsive to receiving data from the input device indicating selection of the add step icon by the input device.

4. The apparatus set forth in claim 3, wherein the visual representation of the add transition icon at least partially overlaps the visual representation of the phase.

5. The apparatus set forth in claim 3, wherein the visual representation of the edit step parameter icon at least partially overlaps the visual representation of the phase.

6. The apparatus set forth in claim 3, wherein the add transition icon comprises a plus sign.

7. The apparatus set forth in claim 3, wherein the edit step parameter comprises a pencil.

8. The apparatus set forth in claim 3, wherein the add step icon comprises a plus sign.

9. The apparatus set forth in claim 1, wherein the pointing device is a mouse.

10. The apparatus set forth in claim 1, wherein the display comprises a recipe construction pane and a location pane, wherein the location pane displays a visual representation of a location in the procedure that is being displayed in the recipe construction pane.

11. An apparatus, comprising:
a display;
an input device, the input device comprises a pointing device;
display logic coupled with the display and the input device;
the display logic is operable to cause a visual representation of a phase of a procedure to be output on the display the display logic is operable to receive data from the input device;
the display logic is operable to receive a predefined input a request to add a comment to the phase from the pointing device;
the display logic is operable to cause a comment box to be displayed on the display and obtain a comment to be added into the comment box via the input device; and
the comment is stored with a link to a phase and a visual representation of a comment icon appears on the phase.

12. The apparatus set forth in claim 11, further comprising:
the display logic receiving data from the pointing device indicating that the visual representation of the comment icon for the phase has been selected; and
the display logic is operable to cause a comment linked to the phase to be displayed in a comment pane.

13. The apparatus set forth in claim 11, further comprising:
the display logic is operable to receive data from the pointing device indicating the visual representation of the comment icon for the phase has been selected; and
the display logic causes a plurality of comments to be displayed in the comment pane, the plurality of comments includes the comment linked to the phase responsive to receiving the data from the pointing device indicating the visual representation of the comment icon for the phase has been selected.

14. The apparatus set forth in claim 13, further comprising:
the display logic is operable to receive data from the pointing device indicating a selected comment was selected from the plurality of comments; and
the display logic is operable to display a selected phase that is linked to the selected comment in the recipe window.

15. The apparatus set forth in claim 13, wherein the display further comprises a location pane, wherein the location pane displays a visual representation of a location in the procedure that is being displayed in the recipe construction pane.

16. An apparatus, comprising:
a display, the display is operable to display a vertical navigation bar, a parameter pane and a recipe construction pane;
an input device, the input device comprises a pointing device;
display logic coupled with the display and the input device;
the display logic is operable to receive data from the input device;
the display logic is operable to cause a visual representation of a recipe element to be output in the recipe construction pane;
the display logic is operable to receive an edit recipe parameters input from the pointing device;
the display logic is operable to cause parameters for the recipe element to be displayed in the parameter pane in response to receiving the edit parameters input;
the display logic is operable to receive a predefined defer input for a selected parameter for the recipe element from the input device;
the display logic is operable to automatically display a visual representation of available levels that have a matching data type for the selected parameter;
the display logic is operable to receiving a level selection input for the selected parameter to cause a confirmation prompt to appear on the display;
the display logic is operable to receive an input from the input device via the confirmation prompt confirming a deferment for the selected parameter to cause the parameter to defer to a level corresponding to the level selection input; and
the display logic upon confirmation of the deferment is operable to cause the parameter to be deferred to a level that corresponds to the level selection input and display a visual representation of the deferment.

17. The apparatus set forth in claim 16, wherein the predefined defer input comprises selecting predefined as an origin for the parameter.

18. The apparatus set forth in claim 16, further comprising:
the visual representation of available levels comprises a plurality of chip icons, where one of the plurality of chip icons represents a current level and at least one of the other plurality of chip icons that represent available levels for deferment of the selected parameter;
the display logic is operable to cause the chip icon at the current level to be faded in comparison with the at least one of the other plurality of chip icons that represent available levels for deferment of the selected parameter while waiting for a level selection input;
the level selection input comprises selecting a chip icon from the at least one of the other plurality of chip icons for a selected level;
the display logic is operable to cause a value for the selected parameter to defer to the level of the at selected level; and
the display logic is operable to provide a visual representing of the deferment.

19. The apparatus set forth in claim 16, wherein the display further comprises a location pane, wherein the location pane displays a visual representation of a location in the procedure that is being displayed in the recipe construction pane.

20. The apparatus set forth in claim 16, further comprising
the display logic responsive to the predefined input to cause an add parameter prompt to appear;
the display logic is operable to receive from the input device data representative of an added parameter responsive to receiving the predefined input; and
the display logic is operable to receiving a defer selection as an origin for the added parameter to cause added parameter to be the selected parameter.
